(19) United States
(12) Patent Application Publication
(10) Pub. No.: US 2015/0196157 A1
(43) Pub. Date: Jul. 16, 2015

(54) METHODS AND SYSTEMS TO SECTIONAL COOKING AND STORAGE SOLUTIONS

(71) Applicant: Jason Swisth, Edmonton (CA)

(72) Inventor: Jason Swisth, Edmonton (CA)

(21) Appl. No.: 14/599,442

(22) Filed: Jan. 16, 2015

(30) Foreign Application Priority Data
Jan. 16, 2014 (CA) 2839786

(51) Int. Cl. A47J 27/13; B65D 25/28; B65D 43/02

(52) U.S. Cl. CPC A47J 27/13; B65D 43/02; B65D 25/28; B65D 2525/285

(57) ABSTRACT

This invention relates to cookware and storage solutions and more particularly to solutions providing multipart cookware supporting different cooking activities with integral storage solutions.

### CROSS-REFERENCE TO RELATED APPLICATIONS

This patent application claims the benefit of Canadian Patent Application 2,839,786 entitled “Methods and Systems for Sectional Cooking and Storage Solutions”, the entire contents of which are incorporated by reference.

### FIELD OF THE INVENTION

This invention relates to cookware and storage solutions and more particularly to solutions providing multipart cookware supporting different cooking activities with integral storage solutions.

### BACKGROUND OF THE INVENTION

Cookware and bakeware are two types of food preparation containers commonly found in a kitchen. Cookware comprises cooking vessels, such as saucepans and frying pans, intended primarily for use on a stove or range cooktop whereas bakeware comprises cooking vessels intended primarily for use inside an oven. Some utensils are both cookware and bakeware. Generally, the choice of material for cookware and bakeware items has a significant effect on the item's cost and performance, particularly in terms of thermal conductivity and how much food sticks to the item when in use. Some choices of material also require special pre-preparation of the surface—known as seasoning—before they are used for food preparation. Many materials for both bakeware and cookware have remained essentially unchanged over time whereas others are comparatively recent innovations. For example, cast iron and ceramics have been around for hundreds to thousands of years whilst Pyrex™ glass and aluminum have been common within the last hundred years. Manufacturers include Corning (Pyrex™), Le Creuset (ceramic, cast iron), All-Clad (aluminum, stainless steel), Lodge (cast iron), Henckels (stainless steel), Lagostina (stainless steel), Cuisinart (stainless steel, aluminum), T-Fal (stainless steel, aluminum), and KitchenAid (stainless steel, aluminum).

At the same time within the modern developed world a very wide range of food containers have been employed over time from many different materials. In the past few hundred years these have evolved from earthenware and stoneware bowls/trays through ceramics, glass and today plastics. Typically these food containers are employed to store ingredients prior to cooking and/or store cooked dishes for subsequent re-heating, use when cold, or use in subsequent cooking and/or baking With plastic storage containers many of these exploit low density polyethylene formed into plastic bags or plastic boxes from suppliers such as Tupperware, KitchenAid, Ziploc, Rubbermaid, and Lock&Lock, many of which are known throughout much of the developed world.

Today with bakeware, which are generally shallow trays, a user may typically cover after baking using aluminum foil or plastic film but these prevent generally the placement of anything on top of these due to the thin flexible nature of the aluminum foil and plastic film. Some, such as Dutch ovens, may be stored using their own lid. However, with cookware the cooked food is transferred from them into a food container, sealed, and stored. Subsequently, these cooked foods if being cooked with other than a microwave oven are then transferred back to cookware/bakeware. Accordingly, it would be beneficial to provide cooks with products allowing their use as cookware (or bakeware) and food storage containers.

Additionally, during the cooking process many recipes will result in the cook using two or more items of cookware due to their different attributes and still when the cook is finished either the full dish cooked or leftovers are transferred to one or more food storage containers. For example, a frying pan provides a clear open area allowing moisture to be removed quickly, such as when frying onions or mushrooms, which are then transferred to another dish for combination with other ingredients and then ultimately may be transferred again to third dish due to the addition of additional ingredients, such as stock, wine, water, etc. for longer term low temperature boiling or simmering. Then the contents or the remaining content after the meal are transferred to a food storage container. Accordingly, it would be beneficial to provide cooks with a single solution allowing them to configure their cookware/bakeware to their cooking activity and provide at the end with a food storage container solution.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to cookware and storage solutions and more particularly to solutions providing multipart cookware supporting different cooking activities with integral storage solutions.

In accordance with an embodiment of the invention there is provided a device comprising:
a first element comprising a base for receiving heat from a source and at least a first sidewall having a first feature formed at least one of upon and within a first predetermined portion of the at least a first sidewall;
a second element comprising at least a second sidewall having a second feature formed at least one of upon and within a first predetermined portion of the at least a second sidewall and for demountably mating with the first feature; and
a lid having a fitting for demountably attaching the lid to either a second predetermined portion of the at least the first sidewall and a second predetermined portion of the at least a second sidewall.

In accordance with an embodiment of the invention there is provided a cookware set comprising:
a plurality of base elements, each base element comprising a base and at least a sidewall;
a plurality of expansion elements, first predetermined portions of the expansion elements for demountably mounting to each base element of the plurality of base elements and second predetermined portions of the expansion elements for demountably mounting to third predetermined portions of the plurality of expansion elements; and
a plurality of lids, each lid for demountably mounting to fourth predetermined portions of the plurality of expansion elements and a predetermined portion of the base elements.

In accordance with an embodiment of the invention there is provided a method comprising providing a cookware set for a user, the cookware set allowing the user to start preparing a dish with a base element of the cookware and to subsequently during preparing the dish add at least one expansion element onto the base element and continue preparing the dish.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts prior art cookware;

FIG. 1B depicts prior art bakeware;

FIG. 2 depicts food storage solutions according to the prior art;

FIG. 3 depicts a base element for a sectional cooking and storage solution according to an embodiment of the invention;

FIG. 4 depicts a base element with expansion element for a sectional cooking and storage solution according to an embodiment of the invention;

FIG. 5 depicts base element and base—expansion elements in storage solution mode for a sectional cooking and storage solution according to an embodiment of the invention;

FIG. 6 depicts expanding a base element with multiple expansion elements for a sectional cooking and storage solution according to an embodiment of the invention;

FIG. 7 depicts a compact storage mode for base—expansion element—lid combinations with different capacities for a sectional cooking and storage solution according to an embodiment of the invention;

FIGS. 8A and 8B depict examples of interface structures between a base element/expansion element or expansion elements for a sectional cooking and storage solution according to an embodiment of the invention;

FIG. 9 depicts expanding a base element with multiple expansion elements for a sectional cooking and storage solution according to an embodiment of the invention;

FIG. 10 depicts expanding a base element with multiple expansion elements for a sectional cooking and storage solution according to an embodiment of the invention;

FIG. 11 depicts an interface structure between a base element/expansion element or expansion elements for a sectional cooking and storage solution according to an embodiment of the invention allowing the sectional cooking and storage solution to operate as a pressure cooker;

FIG. 12 depicts expanding a base element with a reduction elements for a sectional cooking and storage solution according to an embodiment of the invention;

FIG. 13 depicts varying a base element with multiple expansion elements for a sectional cooking and storage solution according to an embodiment of the invention;

FIG. 14 depicts a multi-segment expansion option for a sectional cooking and storage solution according to an embodiment of the invention; and

FIG. 15 depicts a multi-segment expansion option for a sectional cooking and storage solution according to an embodiment of the invention.

### DETAILED DESCRIPTION

The present invention is directed to cookware and storage solutions and more particularly to solutions providing multipart cookware supporting different cooking activities with integral storage solutions.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

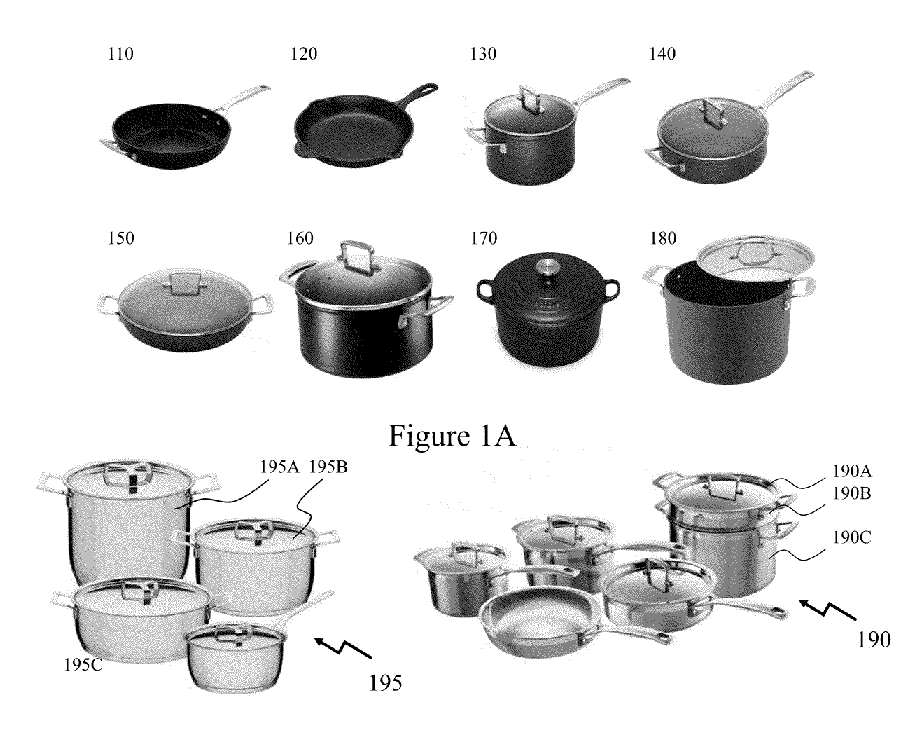

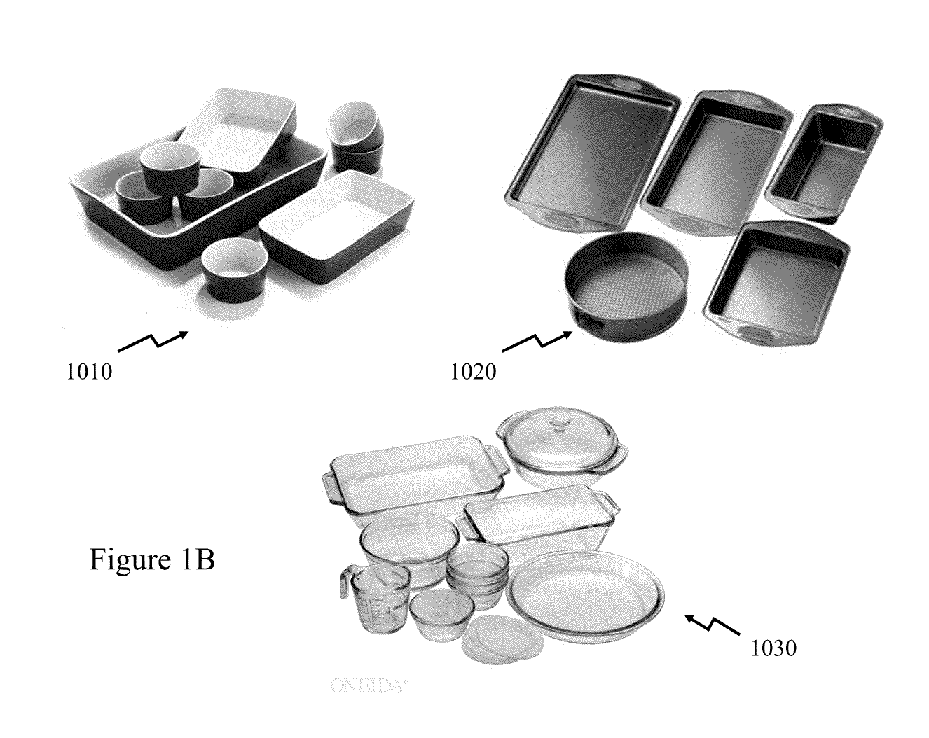

Referring to FIG. 1A there is depicted prior art cookware including frying pan 110, skillet 120, handled saucepan 130, covered fry pan 140, casserole pan 150, saucepan 160, Dutch oven 170, and stock pot 180. These prior art cookware elements are offered in different combinations of elements as well as capacities, e.g. 6″ frying pan. 10″ frying pan, 1 quart saucepan, 2 quart saucepan, and 5 quart saucepan by different suppliers employing different materials. Typical materials include aluminum, stainless steel, and ceramic coated steel. Additionally, depicted in FIG. 1 are first and second cookware sets 190 and 195 respectively. First cookware set 190 comprises a steamer having lid 190A, steamer body 190B, and pan 190C. Steamer body 190B has a base with a plurality of holes allowing steam from boiling water in pan 190C to permeate through steamer body 190B which because of lid 190A builds within steamer. Second cookware set 195 comprises first to third pots 195A through 195C respectively of varying liquid capacities.

Referring to FIG. 1B there are prior art first to third bakeware sets 1010 to 1030 respectively manufactured from ceramic, non-stick steel, and glass respectively. Generally, such bakeware are rectangular or circular in design and shallow as opposed to most of the cookware items which are deep. However, similar issues arise with these items in that a user may bake or roast food and wish to keep the cooked food subsequently. At the same time a user may again wish to start out frying or roasting an item and then finishing the dish they are cooking by simmering, for example. With the prior art bakeware as with cookware there is no solution to this issue other than the user starting to fry or roast within a deep bakeware item to avoid transferring the cooking food but resulting in a different cooking environment or begin with a shallow tray or dish and transferring the food. Again upon completion of cooking and wishing to store the cooked food or leftovers after the meal the user must transfer the food to a food storage container or struggle with the bakeware and covering it with plastic film or aluminum foil. In this format the user cannot easily store additional items atop due to the nature of the plastic film or aluminum foil.

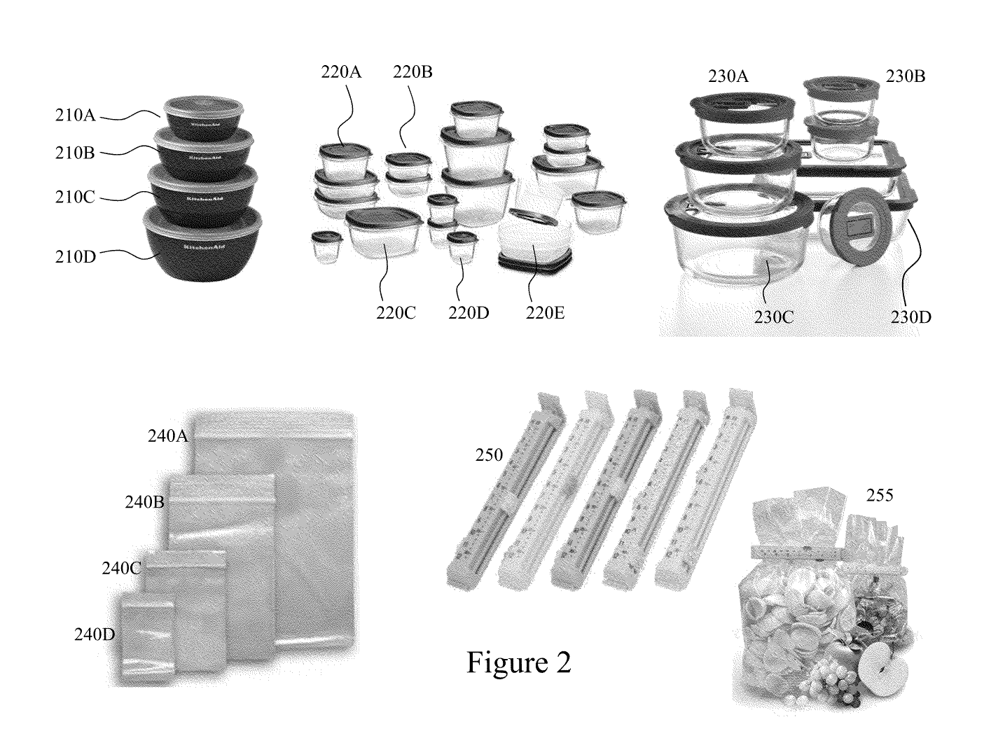

Examples of typical food storage containers within the prior art are depicted in FIG. 2. First to fourth containers 210A through 210D respectively represent larger mixing bowl style food storage containers from a higher end supplier, e.g. KitchenAid, with flexible plastic lids. Fifth to ninth containers 220A through 220E represent lower cost smaller plastic food storage solutions according to the prior intended to store varying quantities with varying geometries including those with circular, rectangular, and square cross-sections. Each of fifth to ninth containers 220A through 220E having a matching lid geometry, generally with an engagement to the upper edge of their respective one of fifth to ninth containers 220A through 220E such that the contents are sealed against the external environment (reducing food spoiling, tainting etc.) or avoiding spills and leaks if they are knocked over, dropped, etc. Other food storage containers such as first to fourth Pyrex containers 230A through 230D respectively allow the user to take stored food and transfer it to a microwave and/or oven without transferring but are generally aimed at re-heating previously cooked food or cooking food that has been previously “assembled” such as a lasagna wherein the meat, onions, sauce, etc. have been cooked separately and then “assembled” with the sheets of lasagna pasta for subsequent cooking. In these instances the user must select the appropriate sized container and proceed from there.

A very low cost solution is the plastic bag, such as depicted by first to fourth self-sealable bags 240A to 240D respectively and bag 255. With first to fourth self-sealable bags 240A to 240D respectively a user may pour or place cooked food into the appropriate sized container and then seal the interlocking plastic strip seal along one edge of the container. This insertion of a single strip of plastic between a second pair of plastic strips designed under low force to retain the single strip provides for sealing of the contents from the external environment and leak/spill protection under regular handling. In contrast bag 255 is sealed using a sealing clamp 250 designed to fit over the open neck of the bag and have one portion clip into retention against another thereby keeping the bag sealed. The use of reusable sealing clamps 250 allows for more expensive designs to include indicators of when the food was placed into the bag or when the sealing clamp 250 was applied. However, in all instances these fail to provide the functionality of scalable cookware which is subsequently sealed for storage/transport.

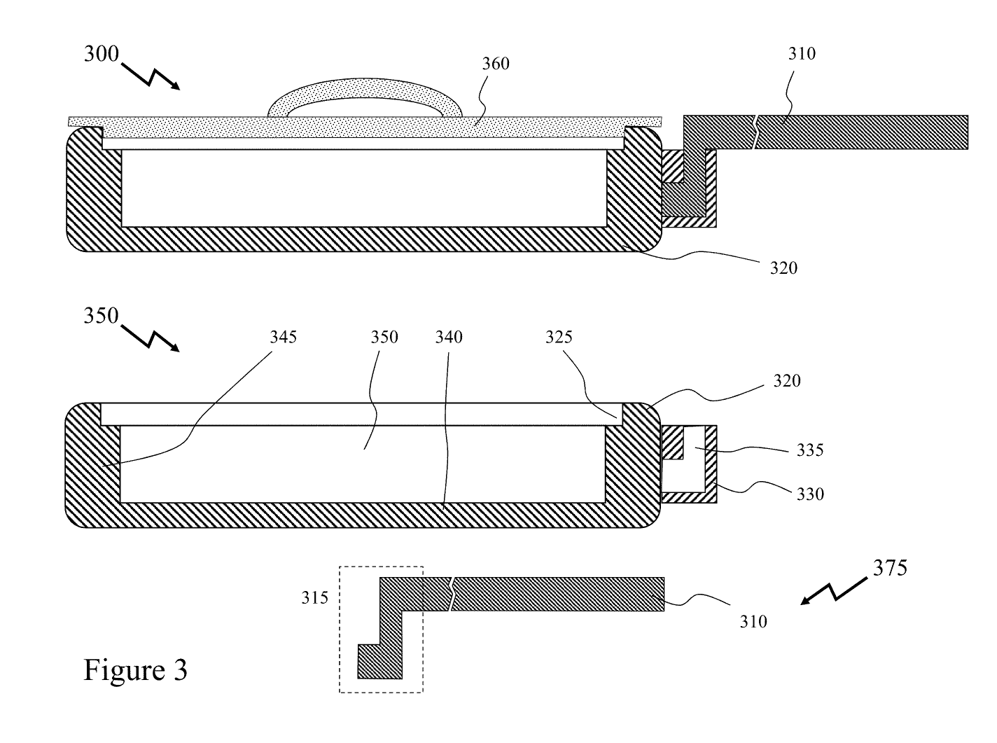

Referring to FIG. 3 there is depicted a base element 320 for a sectional cooking and storage solution according to an embodiment of the invention in first and second images 300 and 350 respectively. In first image 300 the base element 320 is shown with a handle 310 attached and a lid 360 in place. In second image 350 the base element is shown in isolation and comprising base 340 and sidewall(s) 345 which together define an “interior” region 350 of the base element 320. Around the inner edge of the sidewall(s) 345 a lip 325 is formed against which a lower edge of the lid 360 is retained to prevent it sliding off. Disposed on a portion of the outer surface of the sidewall(s) 345 a retaining element 330 with void 335 is disposed. The void 335 being shaped to accept and non-permanently retain handle fitting 315 on the handle 310 as depicted in third image 375.

As depicted handle fitting 315 fits into the void 335 allowing the base element 320 to be moved around on the range, hot, or within the oven. It would be evident to one skilled in the art that a variety of fitting designs for the handle fitting 315 and void 335 may be provided with different retention mechanisms of which some may allow the handle 310 to be removable whilst the base element is in use and within others the handle 310 cannot be removed in use. The shape of base 340 and sidewall(s) 345 forming the base element 320 may be varied such that the base element 320 is circular, square, rectangular, a regular polygon, or an irregular polygon for example.

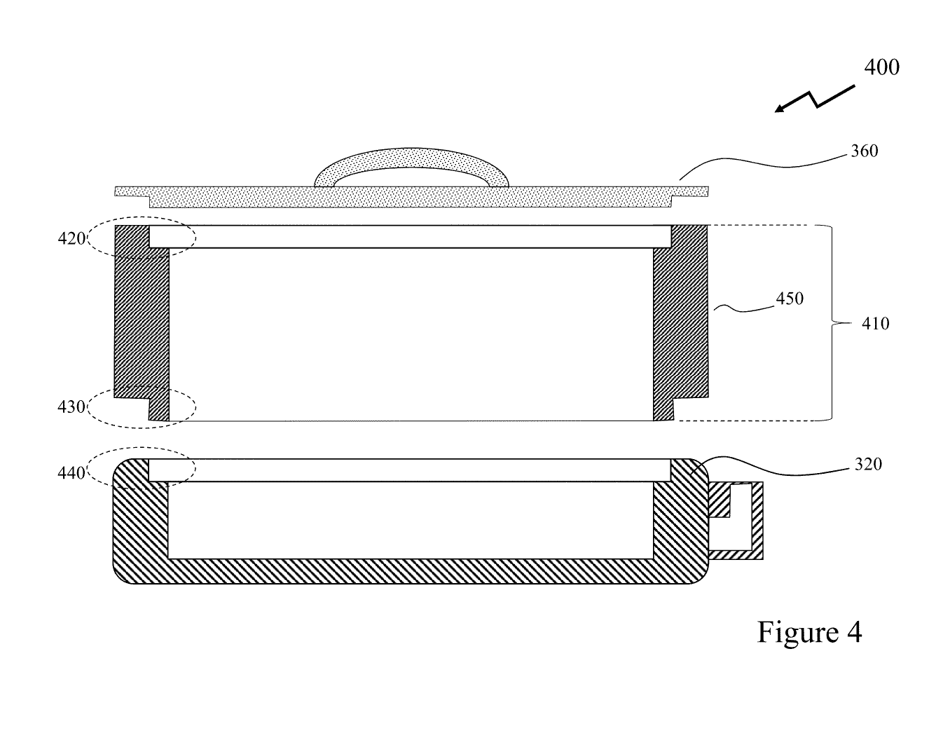

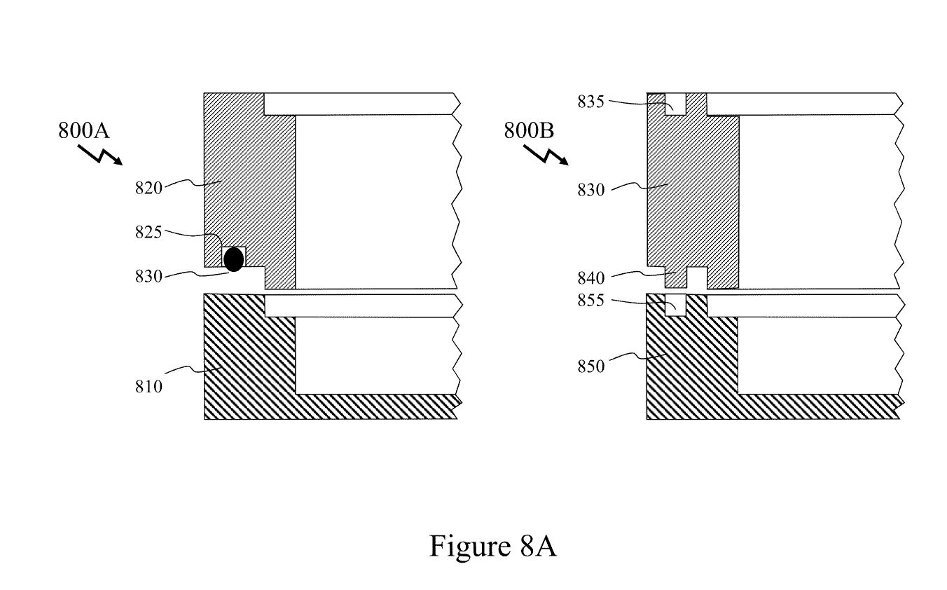

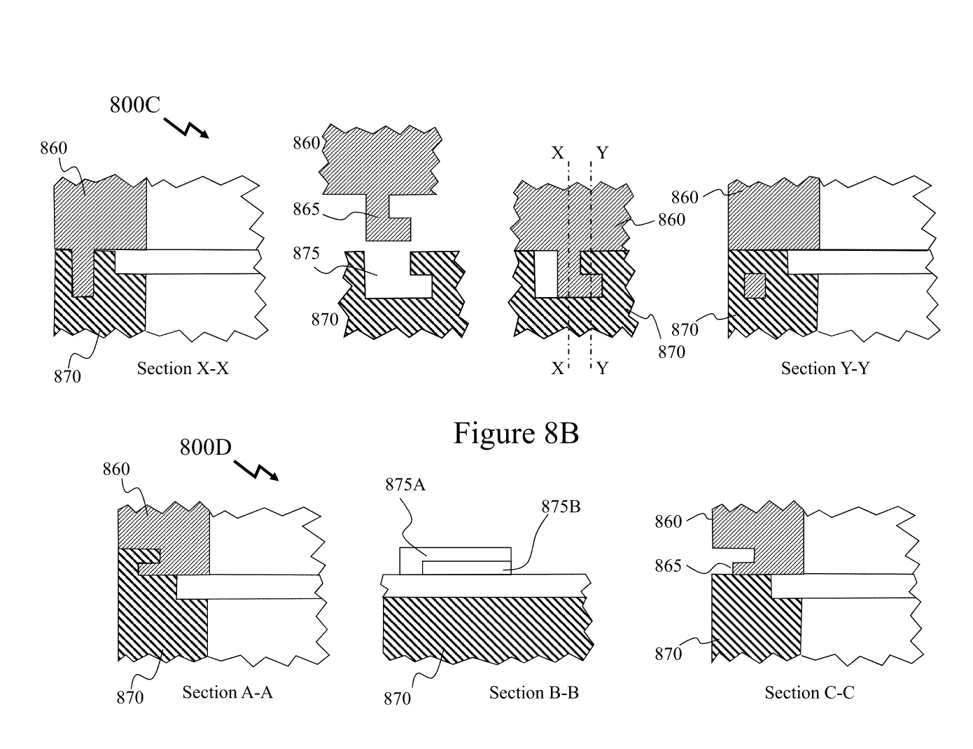

Now referring to FIG. 4 there is depicted a base element 320 with expansion element 410 for a sectional cooking and storage solution according to an embodiment of the invention. As depicted expansion element 410 comprises sidewall 450 having a geometry matching that of base element 320 wherein the lower region 430 of the sidewall 450 fits within upper region 440 of the base element 320, e.g. lip 325 as described in FIG. 3 supra. The upper region 420 of the sidewall 450 has a design comparable to that of upper region 440 of base element 320 to accommodate a lid 360, e.g. lip 325 as described in FIG. 3 supra. Hence, a user having cooked some ingredients within base element 320 may add expansion element 410 and then add more ingredients to their cooking, e.g. stock, wine, etc. and continue cooking. It would be evident that the base element 320 and expansion element 410 may in some embodiments of the invention be interlocked by the user as opposed to relying upon lower region 430 of the sidewall 450 being physically retained by the upper region 440 of the base element 320. Such an interlocking is depicted below in respect of FIG. 8 although other designs would be evident to one of skill in the art.

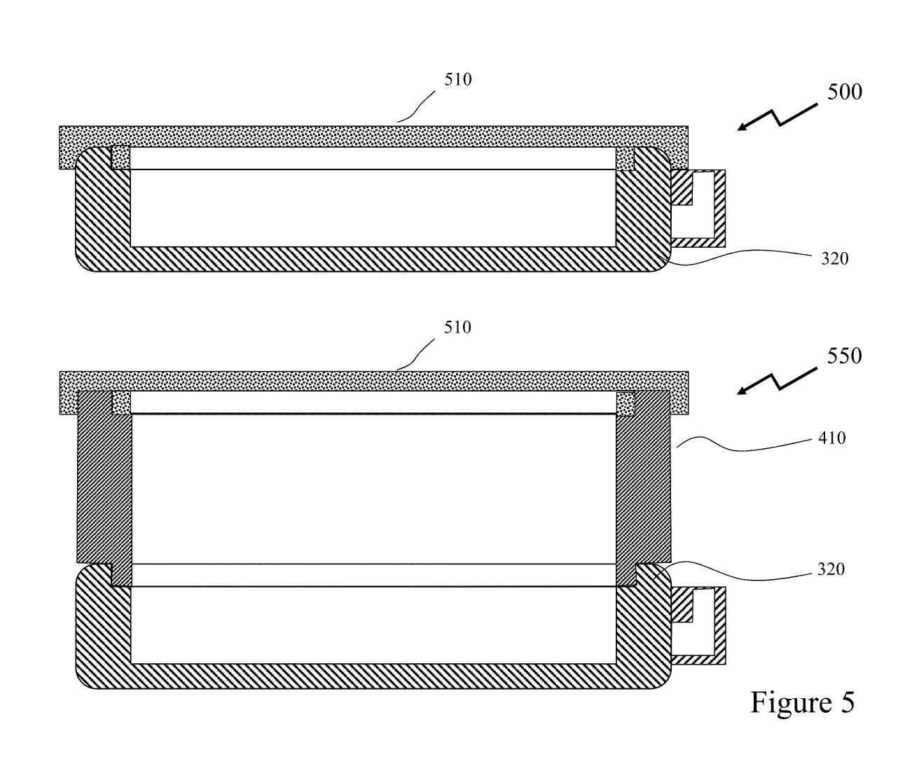

Subsequently, as depicted in FIG. 5 the user may turn the cookware into food storage containers as depicted by first and second images 500 and 550 respectively. As depicted in first image 500 a base element 320 has attached to its upper edge a storage lid 510, such as a compliant plastic compatible with food storage regulations, e.g. Low Density Polyethylene (LDPE). In second image 550 the storage lid 510 is placed onto the upper edge of the expansion element 410. Hence, in second image 550 the user once finished cooking can store the cooked food directly within the cookware, comprising base element 320 and expansion element 410, or having cooked and dished up/eaten the food they have leftovers then these can be stored alternatively using only base element 320.

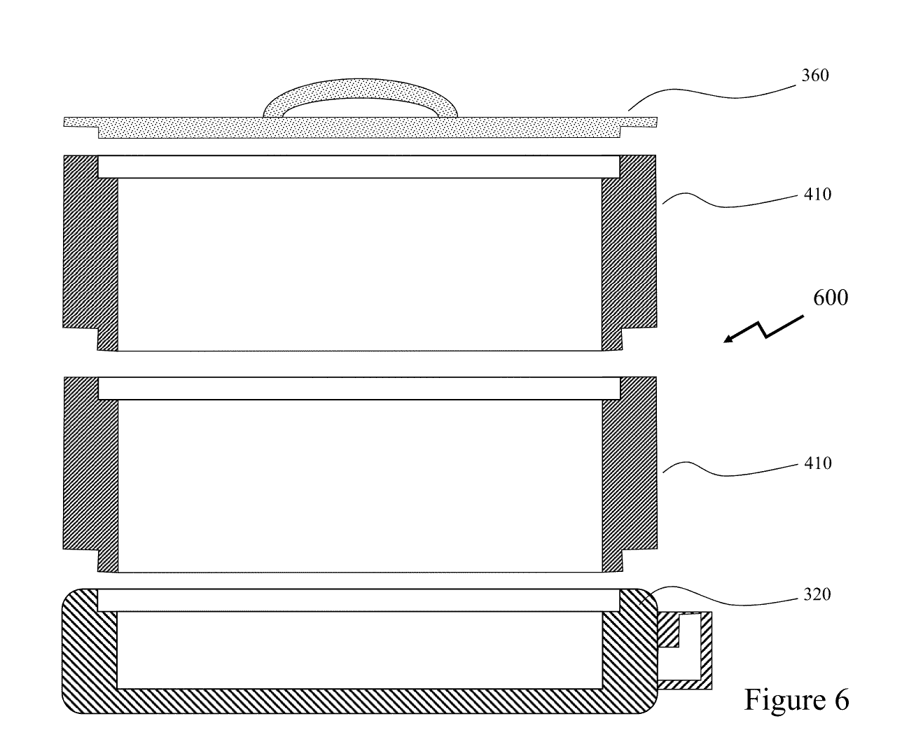

Now referring to FIG. 6 there is depicted the expansion of a base element 320 with multiple expansion elements 410 for a sectional cooking and storage solution 600 according to an embodiment of the invention. Accordingly, the user can start cooking only with base element 320, then add first expansion element 410, continue cooking, and then add second expansion element 410. Subsequently the user may replace the lid 360 with a storage lid, e.g. storage lid 510 in FIG. 5 in multiple configurations, such as base element 320 with both expansion elements 410, base element 320 with single expansion element 410, or base element 320 only. Whilst only base element 320 is depicted as having a fitting upon its outer surface for a handle it would be evident that the expansion elements 410 may themselves have fittings themselves for the temporary attachment of a handle or alternatively may have handles permanently forming part of one or both expansion elements.

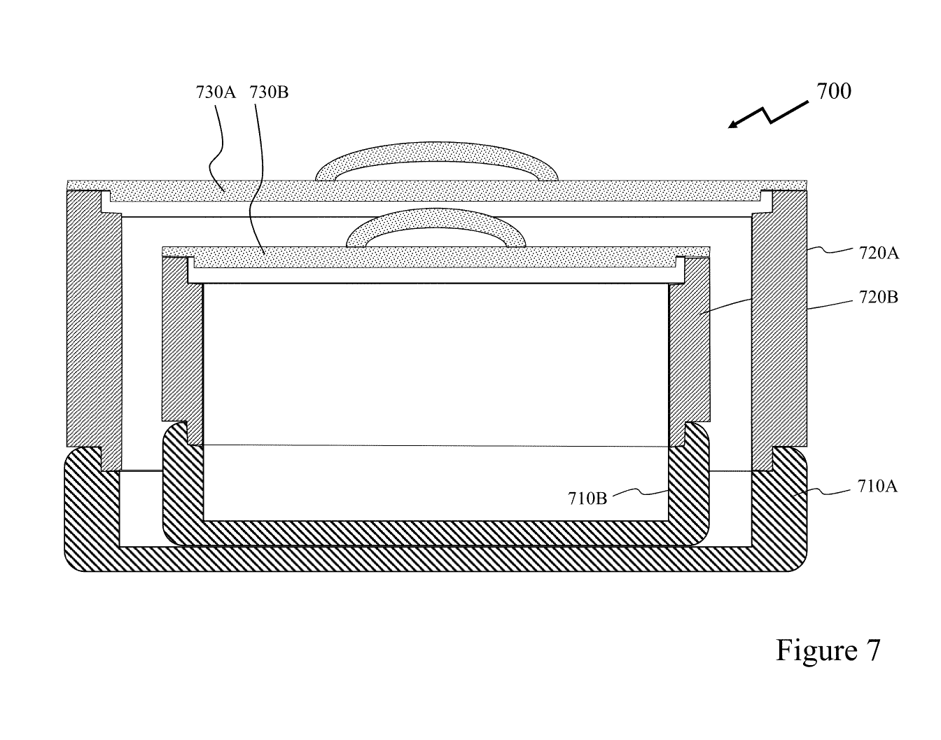

Now referring to FIG. 7 there is depicted a compact storage mode for base element—expansion element—lid combinations with different capacities for a sectional cooking and storage solution 700 according to an embodiment of the invention. As depicted, a first cookware item comprises first base element 710A, first expansion element 720A, and first lid 730A. Disposed within the first cookware item is a second cookware item comprising second base element 710B, second expansion element 720B, and second lid 730B. Accordingly, multiple cookware items may be stored within one another providing reduced space requirements during shipment to retailers, space on retailer's shelves, as well as for the user in their kitchen. It would be evident that based upon the relative dimensions of the cookware items that whilst generally the cookware items fitting within each other would typically be the same, e.g. circular within circular, square within square, etc. that alternatively a circular cookware item may be stored within a square cookware item or vice-versa.

Now referring to FIG. 8A there are depicted examples of interface structures between a base element 810 and expansion element 820 or between pairs of expansion elements 820 for a sectional cooking and storage solution according to an embodiment of the invention. In first image 800A an O-ring 830 housed within groove 825 within the lower edge of expansion element 820 provides a seal against the upper surface of base element 810. Alternatively, as depicted in second image 800B the upper surface of a base element may be formed with a first groove 855 mating with a ridge 840 upon the lower surface of expansion element 830. So that expansion element 830 may support another expansion element 830 being disposed above (atop) it the upper surface of the expansion element 830 may similarly have a second groove 835 for engaging a ridge 840 on the other expansion element 830.

Alternatively, as depicted in third image 800C in FIG. 8B a base element 870 and an expansion element 860 may be “locked” together allowing lifting of the base element 870 from the expansion element 860 in some embodiments of the invention or limiting separation of the elements by knocking for example. Accordingly, expansion element 860 has a tab 865 projecting below which fits within an opening 875 with the base element 870 (or alternatively another expansion element 870) such that subsequent rotation of the base element 870 and expansion element 860 relative to one another locates the tab 865 within the opening 875 such that the vertical movement of the two relative to one another is prevented until the two element have been rotated back again. Fourth image 800D in FIG. 8B presents an alternative tab/slot configuration wherein rather than being vertical the elements are radially engaged in the same plane as the upper/lower surfaces of the elements being joined. Accordingly, referring to Section A-A there is depicted a cross section through base element 870 and expansion element 860 where the tab 865 on the expansion element is within the slot of the base element 870 when the elements have been brought into contact and rotated relative to one another. Section B-B shows a cross-section along inner surface of the base element 870 showing the slot 875B within member 875A. Section C-C shows the cross-section of the base element 870 and expansion element 860 when the two have been brought into contact prior to their rotation relative to each other to engage the tab 865 within the slot 875B of the member 875A.

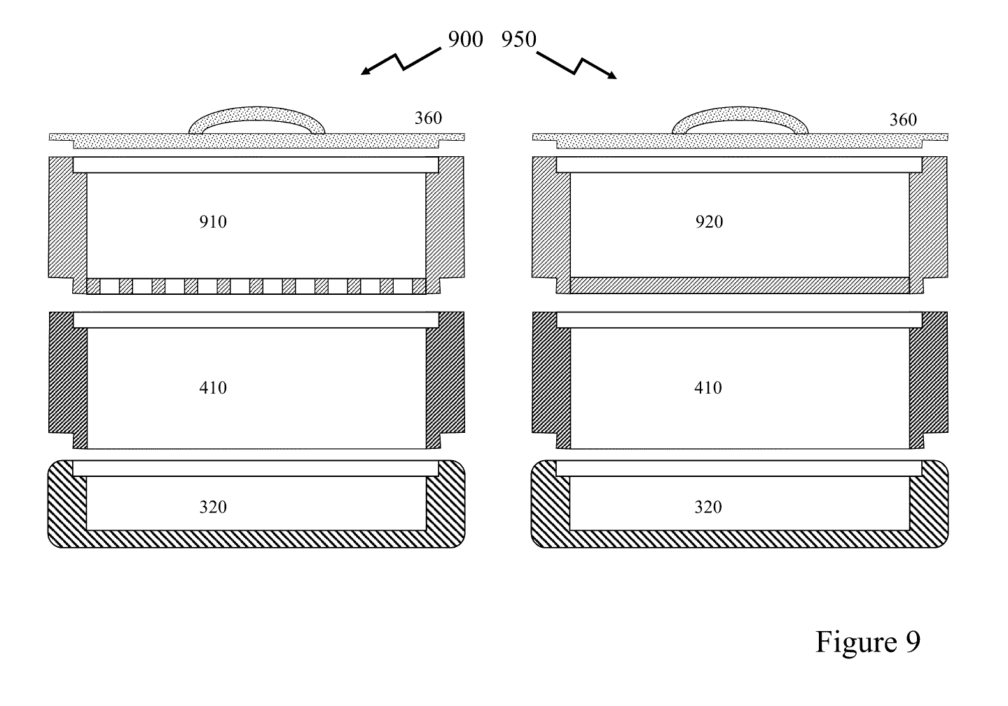

Now referring to FIG. 9 there is depicted first and second cookware assemblies 900 and 950 respectively. Each of the first and second cookware assemblies 900 and 950 respectively comprises a base element 320 with first expansion element 410 and either second or third expansion elements 910 and 920 respectively. Accordingly, with first cookware assembly 900 the user can start cooking only with base element 320, then add first expansion element 410, continue cooking, and then add second expansion element 910 which is perforated allowing them to steam an item atop the items cooking below. Subsequently the user may replace the lid 360 with a storage lid, e.g. storage lid 510 in FIG. 5 in multiple configurations, such as base element 320 with first and second expansion elements 410 and 910 respectively, base element 320 with first expansion element 410, or base element 320 only.

Accordingly, with second cookware assembly 900 the user can combine base element 320 with first expansion element 410, bring for example water to the boil, and then add third expansion element 920 allowing them to gently cook and/or melt within the third expansion element 920 with or without lid 360. Subsequently the user may employ a storage lid, e.g. storage lid 510 in FIG. 5 in multiple configurations, such as base element 320 with first and third expansion elements 410 and 920 respectively, base element 320 with first expansion element 410, base element 320 only, or third expansion element 920. In some embodiments the user may be cooking with other than water within base element 320 and may apply storage lids to both base element 320 and third expansion element 920. Whilst none of the element are depicted as having a fitting upon their outer surface for a handle it would be evident that the first, second and third expansion elements 410, 910 and 920 may themselves have fittings themselves for the temporary attachment of a handle or alternatively may have handles permanently forming part of one or both expansion elements in addition to the same upon base element 320. In some embodiments of the invention third expansion element 920 may be formed from glass as many cooks prefer glass for melting chocolate, for example.

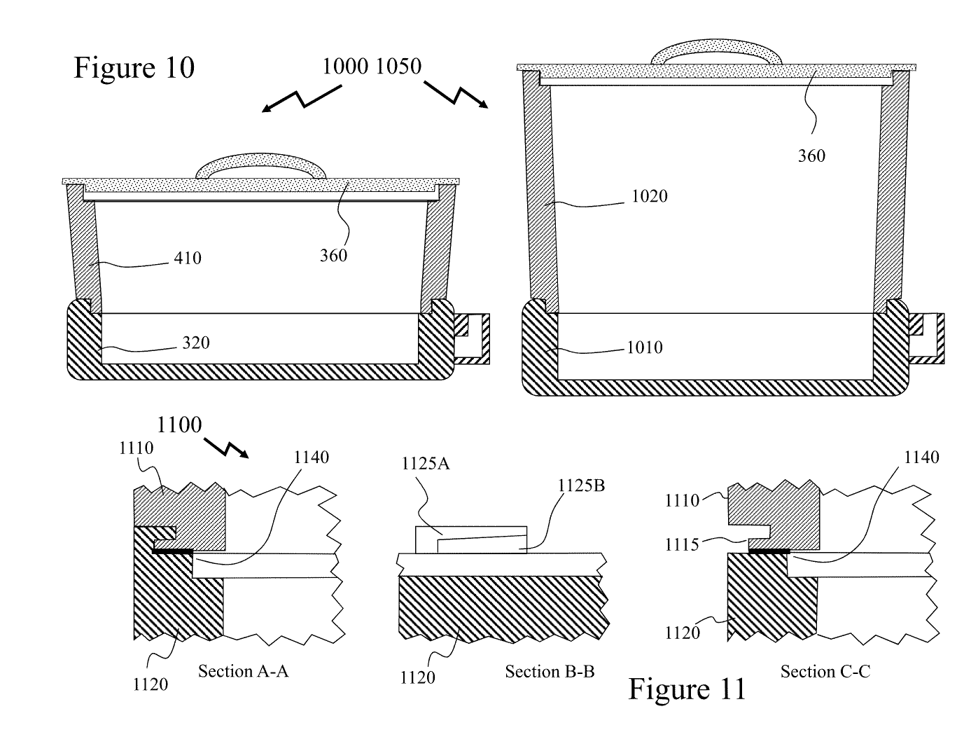

Now referring to FIG. 10 there are depicted first and second cookware assemblies 1000 and 1050 respectively. The first cookware assembly 1000 a first base element 320 with a first expansion element 410. The second cookware assembly 1050 employs respectively comprises a second base element 1010 with a second expansion element 1020. As evident, first base 320 is shallower than second base 1010 and first expansion element 1010 is shorter than second expansion element 1020. However, as the diameters of each of first and second base 320 and 1010 are the same each of the first and second expansions elements 410 and 1020 may be interchanged to either of the first and second bases 320 and 1010 respectively.

Referring to FIG. 11 there is depicted alternative tab/slot configuration to that depicted in fourth image 800D in FIG. 8B. Accordingly, referring to Section A-A there is depicted a cross section through base element 1120 and expansion element 1160 where a tab 1115 on the expansion element is within the slot 1125B of the base element 870 when the elements have been brought into contact and rotated relative to one another with a gasket 1140. Section B-B shows a cross-section along inner surface of the base element 1120 showing the slot 1125B within member 1125A. Section C-C shows the cross-section of the base element 1120 and expansion element 1160 where either the two have been brought into contact with gasket 1140 between them prior to their rotation relative to each other to engage the tab 1115 within the slot 1125B of the member 1125A or the cross-section represents a section adjacent to the member 1125A as these are disposed periodically around the perimeter of the base element 1120. Accordingly, embodiments of the invention exploiting such tab 1115/slot 1125 mechanisms to locate one element against the other with a gasket 1140 may be employed as a re-configurable pressure cooker where a lid is similarly located against either the base element 1120 or an expansion element, usually with a pressure relief valve as part of the lid. Accordingly, the pressure cooker may be a base element with lid or a base element with expansion element and lid for example.

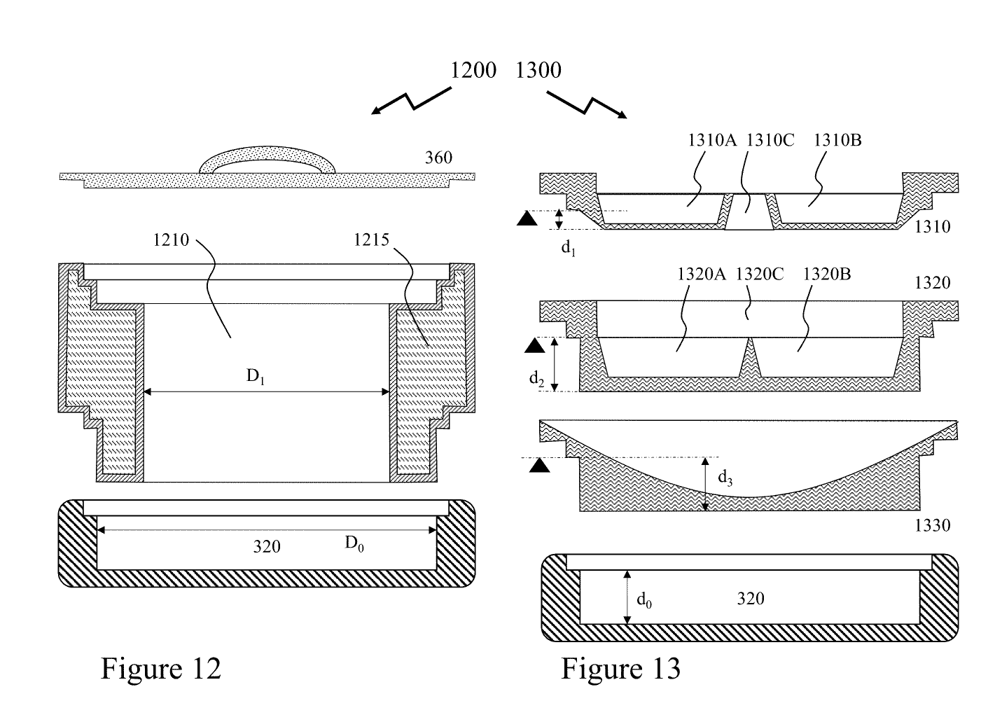

Now referring to FIG. 12 there is depicted cookware assembly 1200 wherein a base element 320 is expanded with an element 1210 which provides for a reduction in the diameter from D₀ to D₁ such that whilst a deeper cooking item is provided through the combination of base element 320 and element 1210 there is not a corresponding volumetric increase to be heated. Element 1210 comprising, for example, a metallic skin with interior 1215 such as air or another material. The metallic skin may include thermal barriers to further limit heat flow from the central region to the other shell. Referring to FIG. 13 there is depicted a base element 320 which has its function varied through first to third expansion elements 1310 to 1330 respectively which provide for a sectional cooking and storage solution according to an embodiment of the invention. As depicted first expansion element 1310 comprises a central opening 1310C together with first and second pockets 1310A and 1310B respectively which are two of a plurality of radially disposed pockets within the first expansion element 1310. As noted the depth of the base of first expansion element 1310 from the reference surface is d₁ such that there is space for liquid within the base element 320 allowing, for example, eggs to be poached within the first and second pockets 1310A and 1310B respectively. This being because d₁<d₀. Now considering second expansion element 1320 this comprises first and second pockets 1310A and 1310B respectively which are two of a plurality of radially disposed pockets within the second expansion element 1320 and are disposed at the bottom of a wide opening 1320C. As noted the depth of the base of second expansion element 1320 from the reference surface is d₂ which is approximately equal to the depth d₀ of the base element 320 such that the bottom of the second expansion element 1320 is in contact with the base element 320 with direct heat transfer allowing, for example, eggs to be fried within the first and second pockets 1320A and 1320B respectively. Third expansion element 1330 similarly has the reference surface at a distance d₃≈d₀ again results in the base of the third expansion element 1330 being in contact with the base element 320 and hence direct heat transfer but now the overall bowl shape of the third expansion element 1330 allows the cooking of omelets or scrambled eggs, for example, or a small stir-fry.

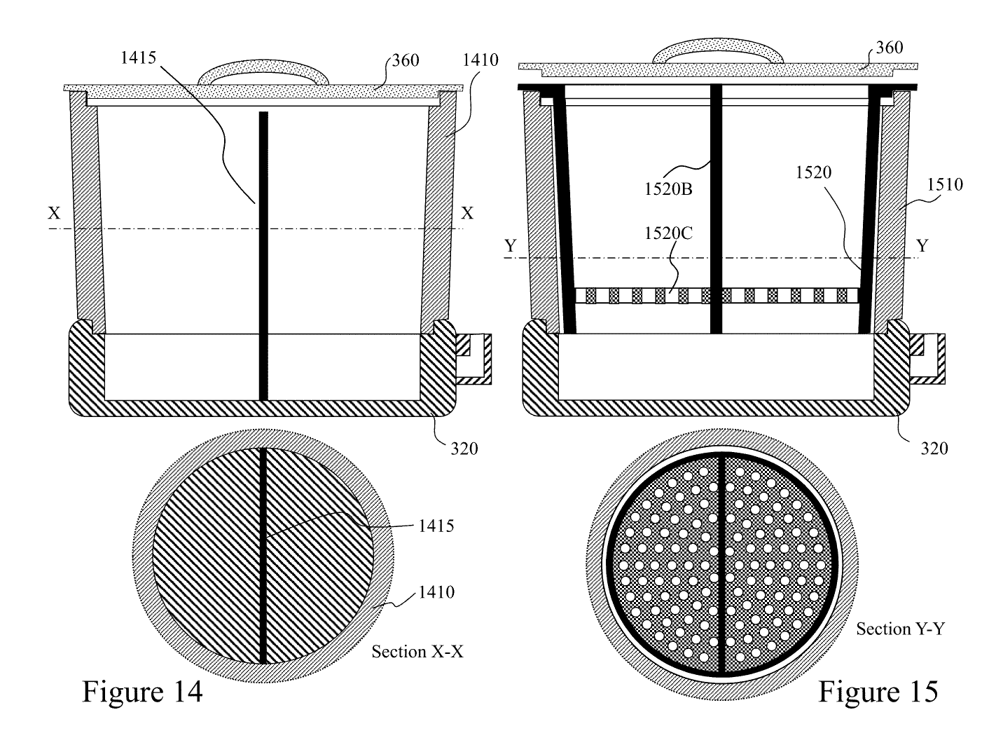

Referring to FIG. 14 there is depicted a multi-segment expansion option for a sectional cooking and storage solution according to an embodiment of the invention. Accordingly, a base element 320 now has expansion element 1410 which fits upon the base element 320 and itself allows the mounting of a lid 360. As such the assembly is similar to second cookware assembly 1050 in FIG. 10 except that the central region of the expansion element 1410 now includes a divider 1415 such that the inner volume of the base element 320 and expansion element 1410 is divided in two allowing two different items to be cooked at the same time upon the same heating element but without their mixing, e.g. two different vegetables may be boiled. It would be evident that divider 1415 may alternatively be several dividers allowing the internal volume of the base element 320 and expansion element 1410 to be divided into three, four or more sections of equal volumes or different volumes, e.g. three divisions of 33% or alternatively one division of 50% and two divisions of 25% each. Referring to FIG. 15 another variant is depicted wherein the expansion element 1410 in FIG. 14 is replaced with expansion element 1510 and a liner 1520 which has within the middle a divider 1520B and rather than being open has a perforated base 1520C. Accordingly, for example, vegetables within the two sections may be steamed rather than boiled. It would be evident that the internal volume of the liner 1520 may be similarly divided into two unequal sections, three equal sections, three differently dimensioned sections, one large and two small sections etc. Without liner 1520 the base element 320 and expansion element 1510 provide a deep saucepan which is converted to a steamer with liner 1520. Optionally, liner 1520 may be silicone whilst expansion element 1510 is stainless steel, for example.

Within the embodiments of the invention described supra in respect of FIGS. 3 through 15 the base elements and expansion elements may be formed as a single piece or they may be formed from multiple pieces (elements) according to a variety of factors, including, but not limited to design, shape, manufacturing processes, material(s), and cost. Materials for a base element may not be automatically employed in its associated expansion elements and associated lid for cooking Materials for the base element and expansion elements may include, but are not limited to, cast iron, anodized aluminum, copper, stainless steel, laminated stainless steel with copper core, laminated stainless steel with aluminum core, borosilicate glass, enamel coated cast iron, carbon steel, enamel over carbon steel, and glass ceramic. Some material selections may be preferable for cookware intended for use upon direct and indirect hob heating elements solely or for hob heating as well as indirect heating within an oven. Some material selections may be preferred for bakeware versus cookware. Within embodiments of the invention materials for the expansion elements may include the above materials but may also include others intended for high temperature exposure such as silicones which may for example provide molds, non-stick reusable mats, steamers, boilers, poachers, cookware lids, etc.

Within the embodiments of the invention described supra in respect of FIGS. 3 through 15 the expansion elements and base element may be temporarily and/or demountably attached to one another. Such temporary and/or demountable attachment means may include those as described and depicted in respect of FIG. 8B as well as other including, but are not be limited to, screw threads such that the expansion element and base element are rotatably mounted/unmounted to one another, spring clamps that attach to the next upper element pulling them together, screw clamps, tabs/slots. These may be used discretely or in combination with one or more sealing mechanisms such as described in respect of FIG. 8A as well as others including, but not limited to, flange gaskets, O-rings, O-ring boss seals, piston ring, diaphragm seal, face seal, and end face seal.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A device comprising:
a first element comprising a base for receiving heat from a source and at least a first sidewall having a first feature formed at least one of upon and within a first predetermined portion of the at least a first sidewall;
a second element comprising at least a second sidewall having a second feature formed at least one of upon and within a first predetermined portion of the at least a second sidewall and for demountably mating with the first feature; and
a lid having a fitting for demountably attaching the lid to either a second predetermined portion of the at least the first sidewall and a second predetermined portion of the at least a second sidewall.

2. The device according to claim 1, further comprising;
a handle having a first elongate section and a first fitting at one end of the handle; and
a second fitting attached to a third predetermined portion of at least one of the first element and second element and dimensioned for demountably retaining the first fitting on the handle.

3. The device according to claim 1, further comprising;
a third feature formed at least one of upon and within a fourth predetermined portion of the at least a second sidewall and for demountably mating with a second feature.

4. A cookware set comprising:
a plurality of base elements, each base element comprising a base and at least a sidewall;
a plurality of expansion elements, first predetermined portions of the expansion elements for demountably mounting to each base element of the plurality of base elements and second predetermined portions of the expansion elements for demountably mounting to third predetermined portions of the plurality of expansion elements; and
a plurality of lids, each lid for demountably mounting to fourth predetermined portions of the plurality of expansion elements and a predetermined portion of the base elements.

5. The cookware set according to claim 4, wherein
at least an expansion element of the first predetermined portions of the expansion elements is placed and rotated in order to demountably mount it to its associated base element of the plurality of base elements.

6. The cookware set according to claim 4, further comprising;
a plurality of gaskets, each gasket for mounting between at least one of a base element and an expansion element and an expansion element and a lid.

7. The cookware set according to claim 4, wherein
a first predetermined portion of the lids are compatible with at least one of use of the cookware set on at least one of a range, a hob and in an oven and use of the cookware within at least one of a refrigerator and a freezer.

8. A method comprising:
providing a cookware set for a user, the cookware set allowing the user to start preparing a dish with a base element of the cookware and to subsequently during preparing the dish add at least one expansion element onto the base element and continue preparing the dish.

9. The method according to claim 8, wherein
the user after preparing the dish may either store the prepared dish directly within the base element and at least one expansion element or store a remaining portion of the prepared dish after a meal comprising the prepared dish within the base element; and
in each instance the same lid is applied to the at least one expansion element or base element.
